(19) United States
(12) Patent Application Publication
(10) Pub. No.: US 2025/0389602 A1
(43) Pub. Date: Dec. 25, 2025

(54) VACUUM PRESSURE SENSOR

(71) Applicant: HONEYWELL INTERNATIONAL INC., Charlotte, NC (US)

(72) Inventors: Veeresh Shivaprakash YAGATI, Charlotte, NC (US); Naveen KUMAR MN, Charlotte, NC (US)

(21) Appl. No.: 19/225,496

(22) Filed: Jun. 2, 2025

(30) Foreign Application Priority Data
Jun. 20, 2024 (IN) 202411047497

(51) Int. Cl. G01L 9/06; G01L 21/00

(52) U.S. Cl. CPC G01L 9/06; G01L 21/00

(57) ABSTRACT

A vacuum pressure sensor may comprise a weld ring and a header element welded to the weld ring. The header element may comprise one or more header pins hermetically sealed to the header element, a piezoresistive sensing element coupled to the header element and electrically coupled to the one or more header pins, a corrugated diaphragm coupled to the header element and the weld ring, wherein the diaphragm, along with the header element, defines a cavity that is configured to contain a material, and a plastic spacer disposed within the cavity. The vacuum pressure sensor may comprise a protruding, pointed edge or a substantially flat edge with no corner break of at least a portion of the header element in physical contact with the metal plate.

### CROSS-REFERENCE TO RELATED APPLICATIONS

This application claims priority pursuant to 35 U.S.C. 119(a) to Indian patent application No. 202411047497, filed Jun. 20, 2024, which application is incorporated herein by reference in its entirety.

### FIELD OF THE INVENTION

Embodiments of the present disclosure generally relate to vacuum pressure sensors and methods for fabrication thereof.

### BACKGROUND

Vacuum pressure sensors measure pressure imparted by various media (e.g., gases, liquids, and/or the like) to a sensing element. In some examples, vacuum pressure sensors are used in semiconductor manufacturing, food processing, and/or other industries which rely on high-vacuum environments. Vacuum pressure sensors, in some examples, are relied upon to withstand high-vacuum environments.

Applicant has identified many technical challenges and difficulties associated with such vacuum pressure sensors and methods for fabrication thereof. Through applied effort, ingenuity, and innovation, many of these identified problems have been solved by developing solutions that are included in embodiments of the present disclosure, many examples of which are described in detail herein.

### BRIEF SUMMARY

Various example embodiments described herein relate to vacuum pressure sensors and methods for fabrication thereof.

In accordance with various embodiments of the present disclosure, a vacuum pressure sensor is provided. In some embodiments, the vacuum pressure sensor comprises: a header element welded to the weld ring, wherein the header element comprises: one or more header pins hermetically sealed to the header element; a piezoresistive sensing element coupled to the header element and electrically coupled to the one or more header pins; a corrugated diaphragm coupled to the header element and the weld ring, wherein the diaphragm, along with the header element, defines a cavity that is configured to contain a material; and a plastic spacer disposed within the cavity, wherein the plastic spacer is coupled to the header element.

In some embodiments, the vacuum pressure sensor further comprises at least one of: a protruding, pointed edge of at least a portion of the header element in physical contact with a metal plate; or a substantially flat edge with no corner break of at least a portion of the header element in physical contact with the metal plate.

In some embodiments, the header element is resistance welded to the metal plate.

In some embodiments, the header element is laser welded to the metal plate.

In some embodiments, the plastic spacer is configured to decrease a volume of the material filling at least the remaining portion of the cavity.

In some embodiments, the piezoresistive sensing element is coupled to the header element via an adhesive; the corrugated diaphragm is coupled to the header element and the weld ring via welding; and the plastic spacer is coupled to the header element via an adhesive.

In some embodiments, the header element defines one or more cavities for material filling or sensing element placement.

In accordance with various embodiments of the present disclosure, a system is provided. In some embodiments, the system comprises a semiconductor manufacturing assembly; and a vacuum pressure sensor comprising: a weld ring; and a header element welded to the weld ring, wherein the header element comprises: one or more header pins hermetically sealed to the header element; a piezoresistive sensing element coupled to the header element and electrically coupled to the one or more header pins; a corrugated diaphragm coupled to the header element and the weld ring, wherein the diaphragm, along with the header element, defines a cavity that is configured to contain a material; and a plastic spacer disposed within the cavity, wherein the plastic spacer is coupled to the header element via an adhesive.

In some embodiments, the system further comprises at least one of: a protruding, pointed edge of at least a portion of the header element in physical contact with a metal plate; or a substantially flat edge with no corner break of at least a portion of the header element in physical contact with the metal plate.

In some embodiments, the header element is resistance welded to the metal plate.

In some embodiments, the header element is laser welded to the metal plate.

In some embodiments, the plastic spacer is configured to decrease a volume of the material filling at least the remaining portion of the cavity.

In some embodiments, the piezoresistive sensing element is coupled to the header element via an adhesive; the corrugated diaphragm is coupled to the header element and the weld ring via welding; and the plastic spacer is coupled to the header element via an adhesive.

In some embodiments, the header element defines one or more cavities for material filling or sensing element placement.

In accordance with various embodiments of the present disclosure, a method is provided. In some embodiments, the method comprises welding a weld ring to a header element; hermetically sealing one or more header pins to the header element; coupling, via an adhesive, a piezoresistive sensing element to the header element; electrically coupling the piezoresistive sensing element to the one or more header pins; welding a corrugated diaphragm between the header element and the weld ring such that the diaphragm, along with the header element, defines a cavity; coupling, via an adhesive, a plastic spacer to the header element within the cavity defined by the diaphragm and the header element; and filling, with a silicone oil, at least a remaining portion of the cavity defined by the diaphragm and the header element.

In some embodiments, the method further comprises at least one of: resistance welding the header element to a metal plate, wherein the header element comprises a protruding, pointed edge in physical contact with the metal plate; or laser welding the header element to the metal plate, wherein the header element comprises a substantially flat edge with no corner break in physical contact with the metal plate.

In some embodiments, the weld ring is comprised of metal and the header element is a transistor outline (TO) header element comprised of metal.

In some embodiments, the method further comprises decreasing, by disposing the plastic spacer within the cavity defined by the diaphragm and the header element, a volume of the silicone oil filling at least the remaining portion of the cavity.

In some embodiments, the silicone oil is ECO-704 oil.

In some embodiments, the method further comprises defining one or more cavities in the header element for oil filling or sensing element placement.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 is a cross-sectional view of an exemplary vacuum pressure sensor;

FIG. 2 is a cross-sectional view of an exemplary vacuum pressure sensor;

FIG. 3A is a perspective view of an exemplary header;

FIG. 3B is a perspective view of an exemplary header;

FIG. 4 is a cross-sectional view of an exemplary header configured for resistance welding;

FIG. 5A is a perspective view of an exemplary header;

FIG. 5B is a perspective view of an exemplary header;

FIG. 6 is a cross-sectional view of an exemplary header configured for laser welding; and.

FIG. 7 is a flowchart of an exemplary method for fabricating a vacuum pressure sensor, in accordance with some embodiments of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” “bottom,” “left,” “right,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The phrases “in one example,” “according to one example,” “in some examples,” and the like generally mean that the particular feature, structure, or characteristic following the phrase may be included in at least one example of the present disclosure and may be included in more than one example of the present disclosure (importantly, such phrases do not necessarily refer to the same example).

If the specification states a component or feature “may,” “can,” “could,” “should,” “would,” “preferably,” “possibly,” “typically,” “optionally,” “for example,” “as an example,” “in some examples,” “often,” or “might” (or other such language) be included or have a characteristic, that specific component or feature is not required to be included or to have the characteristic. Such component or feature may be optionally included in some examples, or it may be excluded.

The word “example” or “exemplary” is used herein to mean “serving as an example, instance, or illustration.” Any implementation described herein as “example” or “exemplary” is not necessarily to be construed as preferred or advantageous over other implementations.

The term “electrically coupled,” “electrically coupling,” “electrically couple,” “electrically connected,” “electrically connecting,” “electrically connect,” “in communication with,” or “in electronic communication with” in the present disclosure refers to two or more elements or components being connected through wired means and/or wireless means, such that signals, electrical voltage/current, data and/or information may be transmitted to and/or received from these elements or components.

The term “in fluid communication with” in the present disclosure refers to two or more elements or components being connected through one or more paths or pathways, such that a fluid or other flowing media may be input to and/or output from these elements or components.

The term “component” may refer to an article, a device, or an apparatus that may comprise one or more surfaces, portions, layers and/or elements. For example, an example component may comprise one or more substrates that may provide underlying layer(s) for the component and may comprise one or more elements that may form part of and/or are disposed on top of the substrate. In the present disclosure, the term “element” may refer to an article, a device, or an apparatus that may provide one or more functionalities.

The term “sensor” refers to a component that may detect, measure, and/or identify any one or more attributes or characteristics of an environment or media, including but not limited to pressure(s).

In some examples, vacuum pressure sensors are configured to measure pressure exerted by media (e.g., gases, liquids, and/or the like) on a sensing element. For example, in mass-flow controllers, vacuum pressure sensors are relied upon to withstand high vacuum (e.g., approximately 10\hat{ }(−3) Pa and/or below) and high temperature (e.g., approximately 90 degrees Celsius and/or above) applications.

In some examples, tungsten inert gas (TIG) welding is used to form mechanical joints between components of vacuum pressure sensors. However, pressure sensors having TIG welded joints suffer, in some examples, from degassing effects (e.g., resulting in the media being sensed coming into direct contact with the sensing element) and are thus not suitable for some applications such as the semiconductor industry, medical and/or pharmaceutical industry, food and/or beverage industry, and/or the like. In some examples, vacuum pressure sensors are a component of devices and/or systems used in semiconductor manufacturing, wherein the devices and/or systems comprise semiconductor manufacturing assemblies (e.g., which operate at high vacuum).

Embodiments of the present disclosure, in some examples, provide vacuum pressure sensors that, in some examples, are operable as a component of devices and/or systems used in semiconductor manufacturing. Embodiments of the present disclosure, in some examples, provide methods for fabricating vacuum pressure sensors.

Example embodiments of the vacuum pressure sensors described herein may include a weld ring and a header element welded to the weld ring. The weld ring, in some examples, may be comprised of metal and/or other materials.

In some examples, the header element may be a transistor outline (TO) header element. The header element may be comprised of metal and/or other materials and may include one or more header pins hermetically sealed to the header element. The header element may further comprise a piezoresistive sensing element coupled to the header element via an adhesive and electrically coupled to the one or more header pins. In addition, the header element may further comprise a corrugated diaphragm coupled to the header element and the weld ring via welding. The diaphragm, along with the header element, may define a cavity.

The header element may further comprise a spacer disposed within the cavity. The spacer may be comprised of plastic and/or other materials and may be coupled to the header element via an adhesive. The header element may further include silicone oil configured to fill at least a remaining portion of the cavity that, in some examples, is partially filled by the spacer. The spacer may be configured to decrease a volume of the silicone oil filling at least the remaining portion of the cavity. The silicone oil may be ECO-704 oil and/or other oils. The header element may define one or more holes for oil filling. The header element may define one or more grooves in which the sensing element may be placed.

Example embodiments of the vacuum pressure sensors described herein may also include a protruding and/or pointed edge of at least a portion of the header element that is in physical contact with and, in some examples, may be attached to a metal plate. In examples where the header element has a protruding and/or pointed edge, the header clement may resistance welded to or otherwise joined with the metal plate.

Example embodiments of the vacuum pressure sensors described herein may include a substantially flat edge with no corner break whereby at least a portion of the header element is in physical contact with a metal plate. In examples where the header element has a substantially flat edge with no corner break, the header element is laser welded and or otherwise joined to the metal plate.

Example embodiments of the methods described herein may include welding a weld ring to a header element, hermetically sealing one or more header pins to the header element, coupling (e.g., via an adhesive) a piezoresistive sensing element to the header element, electrically coupling the piezoresistive sensing element to the one or more header pins, welding a corrugated diaphragm between the header clement and the weld ring (e.g., such that the diaphragm and the header clement define a cavity), coupling (e.g., via an adhesive) a plastic spacer to the header clement within the cavity defined by the diaphragm and the header element, and/or filling (e.g., with a silicone oil) at least a remaining portion of the cavity defined by the diaphragm and the header element.

As described herein, embodiments of the present disclosure, in some examples, provide methods for fabrication of vacuum pressure sensors, devices comprising vacuum pressure sensors, and/or systems comprising vacuum pressure sensors.

To address challenges and limitations associated with vacuum pressure sensors and methods for fabrication thereof, various examples of the present disclosure may be provided. For example, various examples of the present disclosure may provide example devices, systems, and/or methods for vacuum pressure sensors and/or fabrication thereof.

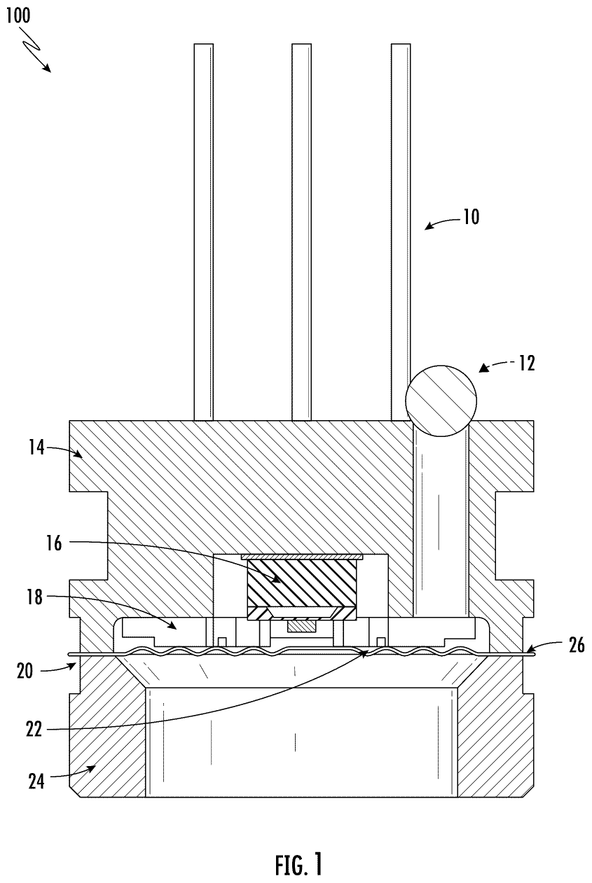

Referring now to FIG. 1, a cross-sectional view of an exemplary vacuum pressure sensor 100 is provided. The sensor 100 includes a weld ring 24, a header clement 14, header pins 10, a sensing element 16, a diaphragm 26, a spacer 18, silicone oil 22, a laser welding location 20, and a ball seal 12. Although the example of FIG. 1 shows one weld ring, one header clement, three header pins on cross-section (six in total), one sensing clement, one diaphragm, one spacer, one amount and/or type of silicone oil, one laser welding location, and one ball seal, any number of these elements may be present in the vacuum pressure sensor 100.

The weld ring 24 may be comprised of metal and/or other materials. The weld ring 24 may define a cavity in which a medium being measured by the sensor 100 may be present. The cavity defined by the weld ring 24 may be at least partially filled by the medium being measured by the sensor 100. The cavity defined by the weld ring 24 may be proximate to the diaphragm 26 (further described herein). The weld ring 24 may be welded to the header element 14 and/or to the diaphragm 26. In one example, the weld ring 24 may be welded to the header element 14 and the diaphragm 26, wherein the diaphragm 26 may be disposed between the header element 14 and the weld ring 24. In another example, the weld ring 24 may be welded to the header element 14. Laser welding or another joining method may be used to couple the weld ring 24 to the header element 14 and/or to the diaphragm 26.

The header clement 14 may be a TO header. In some examples, the header element 14 is comprised of metal and/or other materials. The header element 14 may define at least one cavity. The at least one cavity defined by the header element 14 may comprise (i) a first cavity configured to comprise the spacer 18 and/or a material such as the silicone oil 22, (ii) a second cavity configured to fill the first cavity with the silicone oil 22 and further configured to be sealed by the ball seal 12, (iii) a third cavity configured to comprise the sensing element 16, and/or other cavities. The header element 14 may comprise the header pins 10.

The header pins 10 may comprise at least one header pin. For example, the header pins 10 may comprise six header pins (as shown in the example of FIG. 1). In other examples, the header pins 10 may comprise any number of header pins, as suitable by application. In some examples, the header pins 10 are hermetically sealed to the header element 14. Hermetically scaling the header pins 10 to the header element 14 may prevent media from reaching the sensing clement 16 via the coupling of the header pins 10 and the header clement 14.

The sensing element 16 may be a piezoresistive sensing element. In some examples, the piezoresistive sensing element 16 determines characteristics of the medium being measured based on calculating a change in electrical resistance due to applied strain (e.g., due to imparted pressure and/or the like). The sensing element 16 may be coupled to the header clement 14 via an adhesive (e.g., an industrial-grade adhesive and/or the like). In some examples, the sensing element 16 is coupled to the header element 14 in the third cavity defined by the header clement 14. The sensing element 16 may be electrically coupled to the header pins 10 via wire-bonding.

The diaphragm 26 may be a corrugated diaphragm. For example, a corrugated diaphragm such as the diaphragm 26 may provide a flexible diaphragm having high endurance (e.g., withstanding up to approximately 10\hat{ }6 cycles). In some examples, the diaphragm 26 is disposed between the weld ring 24 and the header clement 14 such that the diaphragm 26 acts as a barrier between the medium being measured and the sensing element 16 comprised by the third cavity defined by the header element 14. The diaphragm 26 may be coupled to the weld ring 24 and/or the header clement 14 via welding. For example, the diaphragm 26 may be laser welded to the weld ring 24 and the header element 14. The diaphragm 26, along with the header element 14, defines a cavity (e.g., the first cavity defined by the header element 14).

The spacer 18 may be comprised of plastic and/or other materials. In some examples, the spacer 18 define at least one cavity for the header pins 10 and/or the sensing element 16. The spacer 18 may be disposed within the cavity defined by the header element 14 and the diaphragm 26. The spacer 18 may be configured to fill at least a portion of the cavity defined by the header clement 14 and the diaphragm 26. In some examples, the spacer 18 is configured to decrease the amount of silicone oil 22 used to at least partially fill the cavity defined by the header element 14 and the diaphragm 26.

The silicone oil 22 may be ECO-704 oil and/or other oils. The silicone oil 22 may be an incompressible fluid (e.g., a substantially incompressible fluid). The silicone oil 22 may be configured to fill at least a remaining portion of the cavity defined by the header element 14 and the diaphragm 26 partially filled by the spacer 18.

The laser welding location 20 may be configured to couple the header element 14, the diaphragm 26, and/or the weld ring 24 via laser welding. In some examples, the laser welding location comprises at least a portion of a perimeter of the sensor 100, wherein the perimeter of the sensor 100 defines perimeters of the header element 14, the diaphragm 26, and/or the weld ring 24.

The ball seal 12 may be comprised of a steel ball and/or other seals. The ball seal 12 may be configured to seal the cavity through which the silicone oil 22 is dispensed. For example, the ball seal 12 may be resistance welded to the header element 14 once the silicone oil 22 is dispensed.

The vacuum pressure sensor 100 may measure pressures of a medium being measured under vacuum. Vacuum pressure may be imparted to the diaphragm 26. In some examples, the vacuum pressure is depicted as negative pressure. The vacuum pressure may be transmitted to the sense die via the silicone oil 22. Due to the diaphragm 26 and the silicone oil 22, the sensing clement 16 may be protected from the medium being measured (e.g., the medium being measured may be corrosive and/or otherwise damaging to the sensing element 16), thus preventing deterioration of sensor output. The amount (e.g., volume) of silicone oil 22 used in the sensor 100 may be optimized via use of the spacer 18 to allow for improved sensor performance such as improved accuracy and decreased thermal errors. The piezoresistive sensing element may be configured to measure a change in pressure outputs.

Advantages of a vacuum pressure sensor such as the vacuum pressure sensor 100 may include, in some examples, (i) avoiding degassing events based on the use of laser welding and/or resistance welding in the fabrication process, (ii) reducing backpressure effects on the diaphragm 26 based on the use of the silicone oil (e.g., ECO-704 oil), which has a low vapor pressure (e.g., approximately 29.7 Pa at approximately 204 degrees Celsius) and a high boiling point (e.g., approximately 215 degrees Celsius at approximately 0.5 Torr), (iii) optimizing oil volume based on spacer design configured to suit high vacuum pressure requirements over 90 degrees Celsius/90 days/10\hat{ }−3 Pa pressure, and/or other advantages.

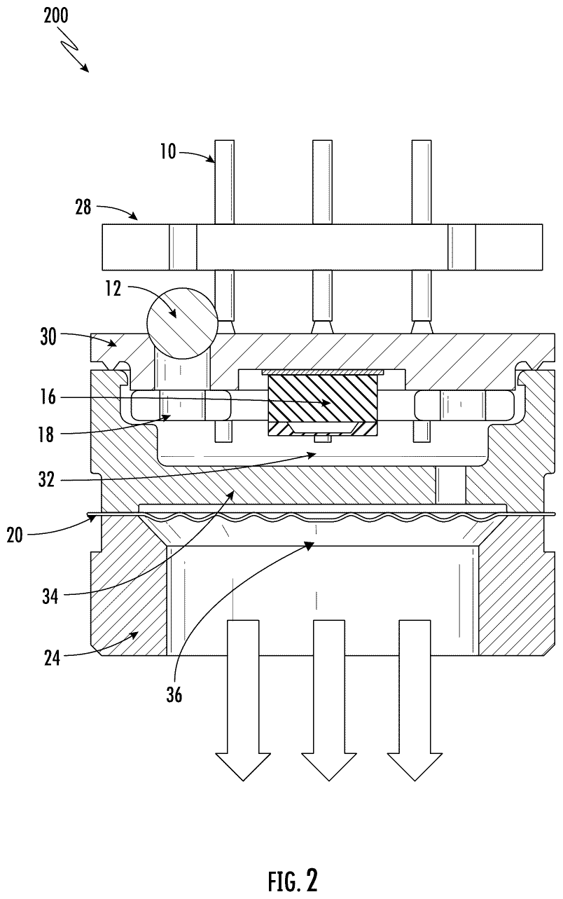

Referring now to FIG. 2, a cross-sectional view of an exemplary vacuum pressure sensor 200 is provided. The sensor 200 includes a weld ring 24, a holder plate 34, a header element 30, header pins 10, a printed circuit board assembly (PCBA) 28, a sensing element 16, a diaphragm 36 a spacer 18, a material (e.g., silicone oil) 32, a welding location 20, and a ball seal 12. Although the example of FIG. 2 shows one weld ring, one holder plate, one header element, three header pins on cross-section (six in total), one PCBA, one sensing element, one diaphragm, one spacer, one amount and/or type of silicone oil, one welding location, and one ball seal, any number of these elements may be present in the vacuum pressure sensor 200.

The weld ring 24 may be comprised of metal and/or other materials. The weld ring 24 may define a cavity in which a medium being measured by the sensor 200 may be present. The cavity defined by the weld ring 24 may be at least partially filled by the medium being measured by the sensor 200. The cavity defined by the weld ring 24 may be proximate to the diaphragm 36 (further described herein). The weld ring 24 may be welded to the holder plate 34 and/or to the diaphragm 36. Laser welding may be used to couple the weld ring 24 to the holder plate 34 and/or to the diaphragm 36.

The holder plate 34 may be comprised of metal and/or other materials The holder plate 34 may define at least one cavity. The at least one cavity defined by the holder plate 34 may comprise (i) a first cavity configured to comprise the sensing element 16, the spacer 18, and/or the silicone oil 32, (ii) a second cavity configured to fill the first cavity with the silicone oil 32, (iii) a third cavity configured to couple the diaphragm 36 and the silicone oil 32, and/or other cavities.

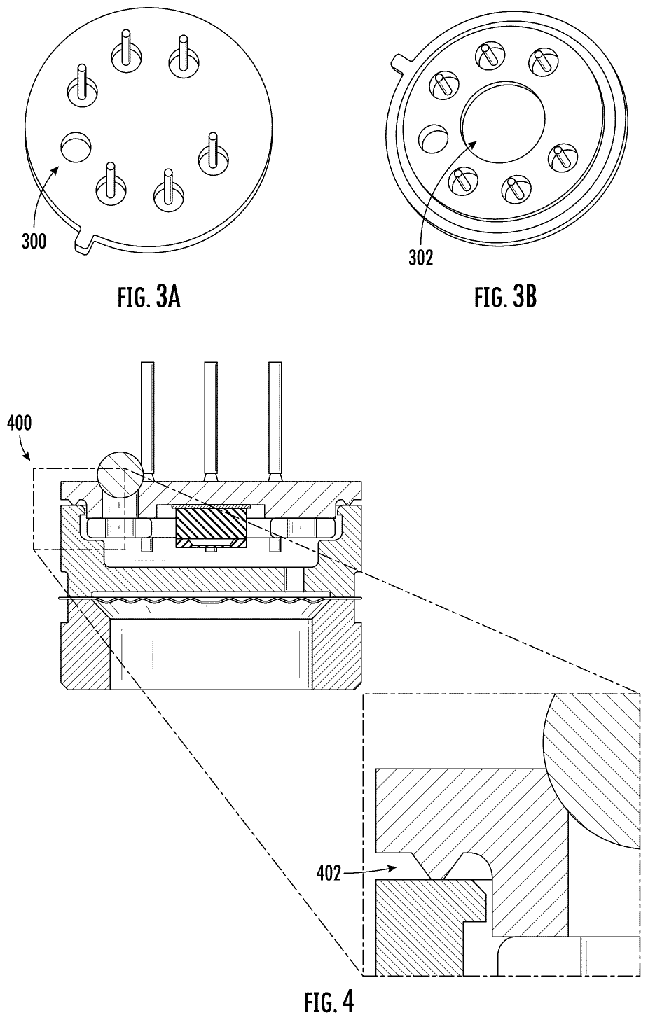

The header clement 30 may be a TO header. In some examples, the header element 30 is comprised of metal and/or other materials. The header clement 30 may define at least one cavity. The at least one cavity defined by the header element 30 may comprise (i) a first cavity configured to comprise the sensing clement 16, (ii) a second cavity configured to fill the first cavity with the silicone oil 32, and/or other cavities. The header clement 30 may comprise the header pins 10. The header clement 30 may be coupled to the holder plate 34. In some examples, the header element 30 is resistance welded to the holder plate 34. In some examples, the header element 30 is laser welded to the holder plate 34. As described herein with respect to FIGS. 3A-3B, 4, 5A-5B, and 6, the header clement 30 may be variously configured to support various types of couplings with the holder plate 34.

The header pins 10 may comprise at least one header pin. For example, the header pins 10 may comprise six header pins (as shown in the example of FIG. 2). In other examples, the header pins 10 may comprise any number of header pins, as suitable by application. In some examples, the header pins 10 are hermetically sealed to the header element 30. Hermetically scaling the header pins 10 to the header element 30 may, in some examples, prevent media from reaching the sensing element 16 via the coupling of the header pins 10, the PCBA 28 and/or the header clement 30.

The PCBA 28 may be configured to electrically couple to the header pins 10. For example, the PCBA 28 may define one or more cavities through which the header pins 10 may be placed. In some examples, the PCBA 28 is configured to sense a resistance change of the piezoresistive sensing element 16 and convert that resistance change to a voltage output. The PCBA 28 may be coupled to one or more other devices, for example, to which the PCBA 28 may transmit a measurement of the pressure imparted to the sensing element 16.

The sensing element 16 may be a piezoresistive sensing clement. In some examples, the piezoresistive sensing element 16 determines characteristics of the medium being measured based on calculating a change in electrical resistance due to applied strain (e.g., due to imparted pressure and/or the like). The sensing element 16 may be coupled to the header element 30 via an adhesive (e.g., an industrial-grade adhesive and/or the like). In some examples, the sensing element 16 is coupled to the header element 30 in the first cavity defined by the header element 30. The sensing clement 16 may be electrically coupled to the header pins 10 via wire-bonding.

The diaphragm 36 may be a corrugated diaphragm. In some examples, the diaphragm 36 is disposed between the weld ring 24 and the holder plate 34 such that the diaphragm 36 acts as a barrier between the medium being measured and the sensing element 16 comprised by the first cavity defined by the header clement 30. The diaphragm 36 may be coupled to the weld ring 24 and/or the holder plate 34 via welding. For example, the diaphragm 36 may be laser welded to the weld ring 24 and the holder plate 34. The diaphragm 36, along with the holder plate 34, defines a cavity.

The spacer 18 may be comprised of plastic and/or other materials. In some examples, the spacer 18 defines at least one cavity for the header pins 10 and/or the sensing element 16. The spacer 18 may be disposed within the cavity defined by the holder plate 34, the header element 30, and/or the diaphragm 36. The spacer 18 may be configured to fill at least a portion of the cavity defined by the holder plate 34, the header clement 30, and/or the diaphragm 36. In some examples, the spacer 18 is configured to decrease the amount of silicone oil 32 used to at least partially fill the cavity defined by the holder plate 34, the header clement 30, and/or the diaphragm 36.

The silicone oil 32 may be ECO-704 oil and/or other oils. The silicone oil 32 may be an incompressible fluid (e.g., a substantially incompressible fluid). The silicone oil 32 may be configured to fill at least a remaining portion of the cavity defined by the holder plate 34, the header clement 34, and/or the diaphragm 36 and partially filled by the spacer 18.

The welding location 20 may be configured to couple the holder plate 34, the diaphragm 36, and/or the weld ring 24 via laser welding. In some examples, the welding location is a laser welding location. In some examples, the welding location 20 comprises at least a portion of the perimeter of the sensor 200, wherein the perimeter of the sensor 200 defines perimeters of the holder plate 34, the diaphragm 36, and/or the weld ring 24.

The ball seal 12 may be comprised of a steel ball and/or other seals. The ball seal 12 may be configured to seal the cavity through which the silicone oil 32 is dispensed. For example, the ball seal 12 may be resistance welded to the header clement 30 once the silicone oil 32 is dispensed.

The vacuum pressure sensor 200 may measure pressures of a medium being measured under vacuum. Vacuum pressure may be imparted to the diaphragm 36. The vacuum pressure may be transmitted to the sensing element 16 via the silicone oil 32. Due to the diaphragm 36 and the silicone oil 32, the sensing element 16 may be protected from the medium being measured (e.g., the medium being measured may be corrosive and/or otherwise damaging to the sensing element 16), thus preventing deterioration of sensor output. The amount (e.g., volume) of silicone oil 32 used in the sensor 200 may be optimized via use of the spacer 18 to allow for improved sensor performance such as improved accuracy and decreased thermal errors. The piezoresistive sensing clement 16 may be configured to measure a change in pressure outputs. The sensing element 16 may comprise a Wheatstone bridge such that pressure changes result in resistance changes of a resistor on the Wheatstone bridge. In some examples, the sensing element 16 is wire-bonded to the header pins 10, and the header pins 10 are electrically coupled to the PCBA 28. The PCBA 28 may sense the change in resistance and accordingly provide a corresponding voltage output. The voltage output may travel through spring terminals and/or pin arrangements of a connector coupled with the vacuum pressure sensor 200.

Advantages of a vacuum pressure sensor such as the vacuum pressure sensor 200 may include, in some examples, (i) avoiding degassing events based on the use of laser welding and/or resistance welding in the fabrication process, (ii) reducing thermal errors and improving sensor performance based on minimizing oil volume due to the at least one cavity used for oil filling, (iii) eliminating additional components configured to provide a path for oil filling, (iv) packaging the sensor 200 to offer multiple configurations (e.g., pressure types, electrical connections, electrical outputs, etc.), (v) eliminating use of high-cost custom headers based on modifying (e.g., machining) TO headers for oil filling and/or sensing element placement, (vi) reducing backpressure effects on the diaphragm 36 based on the use of the silicone oil 32 (e.g., ECO-704 oil), which has a low vapor pressure and a high boiling point, (vii) optimizing oil volume based on spacer design configured to suit high vacuum pressure requirements over 90 degrees Celsius/90 days/10\hat{ }−3 Pa pressure, and/or other advantages.

FIGS. 3A-3B provide exemplary headers comprising various cavities configured for various uses. Referring now to FIG. 3A, a perspective view of an exemplary header is provided. The example header of FIG. 3A shows a cavity 300. The cavity 300 may comprise one or more cavities. The cavity 300 may be a hole through a portion of the header. The header (e.g., the header clement 14, the header element 30, etc.) may be configured (e.g., machined) with the cavity 300. The cavity 300 may allow for oil filling for a vacuum pressure sensor (e.g., the sensor 100, the sensor 200, etc.). Silicone oil (e.g., the silicone oil 22, the silicone oil 32, etc.) may be dispensed into at least a portion of the vacuum pressure sensor via the cavity 300. Referring now to FIG. 3B, a perspective view of an exemplary header is provided. The example header of FIG. 3B shows a cavity 302. The cavity 302 may comprise one or more cavities. The cavity 302 may be a trench, a divot, an etched region, and/or the like in a portion of the header. The header may be configured with the cavity 302. The cavity 302 may allow for a sensing clement (e.g., the sensing clement 16 of FIG. 1, the sensing element 16 of FIG. 2, etc.) to be placed in at least a portion of the sensor 200. The sensing element may be coupled to the header in the cavity 302 via an adhesive.

Referring now to FIG. 4, a cross-sectional view of an exemplary header configured for resistance welding is provided. In the example of FIG. 4, a portion 400 of a header (e.g., the header 30) shows a protruding, pointed edge 402 of at least a portion of the header in physical contact with a holder plate. The header may be machined with the protruding, pointed edge 402. In some examples, the header is a standard part which can be machined with the protruding, pointed edge 402. The protruding, pointed edge 402 is configured to allow for resistance welding at a joint comprising the protruding, pointed edge 402 of the header and a holder plate (e.g., the holder plate B). As shown in FIGS. 3A-3B, edges of the header show the protruding, pointed edge 402 surrounding at least a portion of the perimeter of the header.

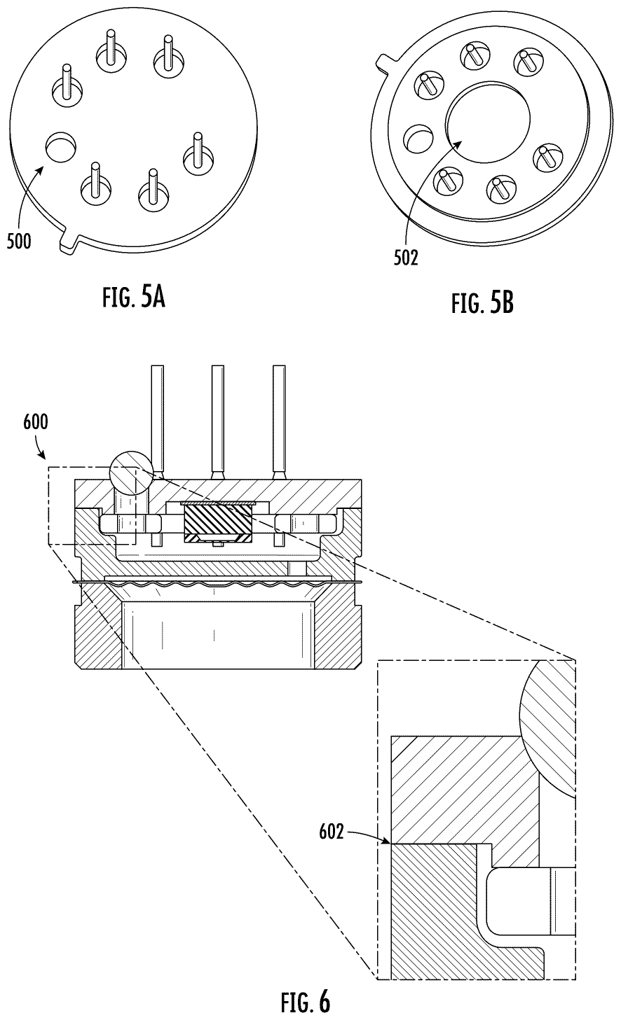

FIGS. 5A-5B provide exemplary headers comprising various cavities configured for various uses. Referring now to FIG. 5A, a perspective view of an exemplary header is provided. The example header of FIG. 5A shows a cavity 500. The cavity 500 may comprise one or more cavities. The cavity 500 may be a hole through a portion of the header. The header (e.g., the header clement 14, the header element 30, etc.) may be configured (e.g., machined) with the cavity 500. The cavity 500 may allow for oil filling for a vacuum pressure sensor (e.g., the sensor 100, the sensor 200, etc.). Silicone oil (e.g., the silicone oil 22, the silicone oil 32, etc.) may be dispensed into at least a portion of the vacuum pressure sensor via the cavity 500. Referring now to FIG. 5B, a perspective view of an exemplary header is provided. The example header of FIG. 5B shows a cavity 502. The cavity 502 may comprise one or more cavities. The cavity 502 may be a trench, a divot, an etched region, and/or the like in a portion of the header. The header may be configured with the cavity 502. The cavity 502 may allow for a sensing element (e.g., the sensing element 16 of FIG. 1, the sensing element 16 of FIG. 2, etc.) to be placed in at least a portion of the sensor 200. The sensing element may be coupled to the header in the cavity 502 via an adhesive.

Referring now to FIG. 6, a cross-sectional view of an exemplary header configured for laser welding is provided. In the example of FIG. 4, a portion 600 of a header (e.g., the header 30) shows a substantially flat edge (e.g., a substantially flat edge with no corner break) 602 of at least a portion of the header in physical contact with a holder plate. The header may be machined with the substantially flat edge with no corner break 602. In some examples, the header is a standard part which can be machined with the substantially flat edge with no corner break 602. The substantially flat edge with no corner break 602 is configured to allow for effective laser welding at a joint comprising the substantially flat edge with no corner break 602 of the header 30 and a holder plate (e.g., the holder plate 34). As shown in FIGS. 5A-5B, edges of the header show the substantially flat edge with no corner break 602 surrounding at least a portion of the perimeter of the header.

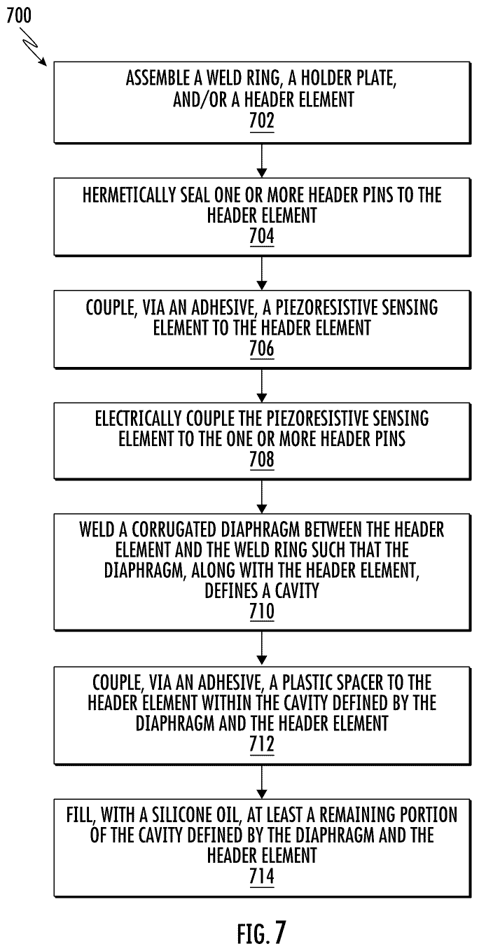

Referring now to FIG. 7, a flowchart of an exemplary method 700 for fabricating a vacuum pressure sensor is provided.

At step/operation 702, a weld ring, a holder plate, and/or a header element may be assembled. In some examples, the weld ring is the weld ring 24 of FIG. 1 or the weld ring 24 of FIG. 2. In some examples, the holder plate is the holder plate 34. In some examples, the header clement is the header element 14 or the header element 30. The weld ring, the holder plate, and the header element may be assembled together such that the weld ring is proximate to the holder plate and the holder plate is proximate to the header element. The weld ring and the header element may be assembled together such that the weld ring is proximate to the header element.

At step/operation 704, one or more header pins may be hermetically sealed to the header element. The one or more header pins may be the header pins 10 of FIG. 1 or the header pins 10 of FIG. 2. The header element may comprise one or more cavities for housing the one or more header pins. In some examples, the one or more header pins are hermetically sealed to the one or more cavities of the header element such that no gas, moisture, and/or other contaminants may not penetrate the hermetic seal.

At step/operation 706, a piezoresistive sensing element may be coupled, via an adhesive, to the header element. The piezoresistive sensing element may be the sensing element 16 of FIG. 1 or the sensing element 16 of FIG. 2. The piezoresistive sensing clement may be a piezoresistive sensing element such that it converts applied strain (e.g., due to pressure of a medium) to a change in electrical resistance.

At step/operation 708, the piezoresistive sensing element may be electrically coupled to the one or more header pins. For example, the piezoresistive sensing element may be wire-bonded to the one or more header pins. Additionally or alternatively, the piezoresistive sensing element may be electrically coupled to a PCBA (e.g., the PCBA 28) wherein the PCBA is configured to convert the change in electrical resistance into an output voltage.

At step/operation 710, a corrugated diaphragm may be welded (e.g., laser welded) between the header element and the weld ring such that the diaphragm, along with the header clement, defines a cavity. The corrugated diaphragm may be the diaphragm 26 or the diaphragm 36. In some examples, the corrugated diaphragm is laser welded to the header element and to the weld ring (e.g., along at least a portion of the perimeter of the corrugated diaphragm). In other examples, the corrugated diaphragm is laser welded to the weld ring and to a holder plate, wherein the holder plate is coupled to the header element on the side opposite the corrugated diaphragm.

At step/operation 712, a plastic spacer may be coupled, via an adhesive, to the header element within the cavity defined by the diaphragm and the header element. In some examples, the cavity is further defined by the holder plate. The plastic spacer may be the spacer 18 of FIG. 1 or the spacer 18 of FIG. 2. The plastic spacer may be configured to fill at least a portion of the volume of the cavity defined by the diaphragm and the header element.

At step/operation 714, at least a remaining portion of the cavity defined by the diaphragm and the header element may be filled with a silicone oil. The silicone oil may be the silicone oil 22 or the silicone oil 32. The silicone oil may be configured to fill at least part of the remaining volume of the cavity defined by the diaphragm and the header element. The silicone oil may be further configured to impart any pressure(s) received by the diaphragm to the sensing element.

Advantages of vacuum pressure sensors as described herein include, in some examples, avoiding degassing events. For example, the laser welding and/or resistance welding in regions coupling various components of the vacuum pressure sensors may prevent and/or decrease degassing events due to forming improved seals (e.g., wherein the improved seals lack molecule-sized leak openings).

Operations and processes described herein support combinations of means for performing the specified functions and combinations of operations for performing the specified functions. It will be understood that one or more operations, and combinations of operations, may be implemented by special purpose hardware-based computer systems which perform the specified functions, or combinations of special purpose hardware and computer instructions.

In some example embodiments, certain ones of the operations herein may be modified or further amplified as described below. Moreover, in some embodiments additional optional operations may also be included. It should be appreciated that each of the modifications, optional additions or amplifications described herein may be included with the operations herein either alone or in combination with any others among the features described herein.

The foregoing method and process descriptions are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” and similar words are not intended to limit the order of the steps; these words are simply used to guide the reader through the description of the methods. Further, any reference to claim elements in the singular, for example, using the articles “a,” “an” or “the,” is not to be construed as limiting the element to the singular and may, in some instances, be construed in the plural.

While various embodiments in accordance with the principles disclosed herein have been shown and described above, modifications thereof may be made by one skilled in the art without departing from the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present disclosure. Furthermore, any advantages and features described above may relate to specific embodiments but shall not limit the application of such issued claims to processes and structures accomplishing any or all of the above advantages or having any or all of the above features.

In addition, the section headings used herein are provided for consistency with the suggestions under 37 C.F.R. § 1.77 or to otherwise provide organizational cues. These headings shall not limit or characterize the disclosure set out in any claims that may issue from this disclosure. For instance, a description of a technology in the “Background” is not to be construed as an admission that certain technology is prior art to any disclosure in this disclosure. Neither is the “Summary” to be considered as a limiting characterization of the disclosure set forth in issued claims. Furthermore, any reference in this disclosure to “disclosure” or “embodiment” in the singular should not be used to argue that there is only a single point of novelty in this disclosure. Multiple embodiments of the present disclosure may be set forth according to the limitations of the multiple claims issuing from this disclosure, and such claims accordingly define the disclosure, and their equivalents, which are protected thereby. In all instances, the scope of the claims shall be considered on their own merits in light of this disclosure but should not be constrained by the headings set forth herein.

Also, systems, subsystems, apparatuses, techniques, and methods described and illustrated in the various embodiments as discrete or separate may be combined or integrated with other systems, modules, techniques, or methods without departing from the scope of the present disclosure. Other devices or components shown or discussed as coupled to, or in communication with, each other may be indirectly coupled through some intermediate device or component, whether electrically, mechanically, or otherwise. Other examples of changes, substitutions, and alterations are ascertainable by one skilled in the art and could be made without departing from the scope disclosed herein.

Many modifications and other embodiments of the disclosure set forth herein will come to mind to one skilled in the art to which these embodiments pertain having the benefit of teachings presented in the foregoing descriptions and the associated figures. Although the figures only show certain components of the apparatuses and systems described herein, various other components may be used in conjunction with the components and structures disclosed herein. Therefore, it is to be understood that the disclosure is not to be limited to the specific embodiments disclosed and that modifications and other embodiments are intended to be included within the scope of the appended claims. For example, the various elements or components may be combined, rearranged, or integrated in another system or certain features may be omitted or not implemented. Moreover, the steps in any method described above may not necessarily occur in the order depicted in the accompanying drawings, and in some cases one or more of the steps depicted may occur substantially simultaneously, or additional steps may be involved. Although specific terms are employed herein, they are used in a generic and descriptive sense only and not for purposes of limitation.

What is claimed is:

1. A vacuum pressure sensor comprising:
a weld ring; and,
a header element welded to the weld ring, wherein the header element comprises:
one or more header pins hermetically sealed to the header element;
a piezoresistive sensing element coupled to the header element and electrically coupled to the one or more header pins;
a corrugated diaphragm coupled to the header element and the weld ring, wherein the diaphragm, along with the header element, defines a cavity that is configured to contain a material; and,
a plastic spacer disposed within the cavity, wherein the plastic spacer is coupled to the header element.

2. The vacuum pressure sensor of claim 1, further comprising at least one of:
a protruding, pointed edge of at least a portion of the header element in physical contact with a metal plate; or
a substantially flat edge with no corner break of at least a portion of the header element in physical contact with the metal plate.

3. The vacuum pressure sensor of claim 2, wherein the header element is resistance welded to the metal plate.

4. The vacuum pressure sensor of claim 2, wherein the header element is laser welded to the metal plate.

5. The vacuum pressure sensor of claim 1, wherein the plastic spacer is configured to decrease a volume of the material filling at least the remaining portion of the cavity.

6. The vacuum pressure sensor of claim 1, wherein:
the piezoresistive sensing element is coupled to the header element via an adhesive;
the corrugated diaphragm is coupled to the header element and the weld ring via welding; and
the plastic spacer is coupled to the header element via an adhesive.

7. The vacuum pressure sensor of claim 1, wherein the header element defines one or more cavities for material filling or sensing element placement.

8. A system comprising:
a semiconductor manufacturing assembly; and
a vacuum pressure sensor comprising:
a weld ring;
a header element welded to the weld ring, wherein the header element comprises:
one or more header pins hermetically sealed to the header element;
a piezoresistive sensing element coupled to the header element and electrically coupled to the one or more header pins;
a corrugated diaphragm coupled to the header element and the weld ring, wherein the diaphragm, along with the header element, defines a cavity that is configured to contain a material; and,
a plastic spacer disposed within the cavity, wherein the plastic spacer is coupled to the header element via an adhesive.

9. The system of claim 8, further comprising at least one of:
a protruding, pointed edge of at least a portion of the header element in physical contact with a metal plate; or
a substantially flat edge with no corner break of at least a portion of the header element in physical contact with the metal plate.

10. The system of claim 9, wherein the header element is resistance welded to the metal plate.

11. The system of claim 9, wherein the header element is laser welded to the metal plate.

12. The system of claim 8, wherein the plastic spacer is configured to decrease a volume of the material filling at least the remaining portion of the cavity.

13. The system of claim 8, wherein:
the piezoresistive sensing element is coupled to the header element via an adhesive;
the corrugated diaphragm is coupled to the header element and the weld ring via welding; and
the plastic spacer is coupled to the header element via an adhesive.

14. The system of claim 8, wherein the header element defines one or more cavities for material filling or sensing element placement.

15. A method comprising:
welding a weld ring to a header element;
hermetically sealing one or more header pins to the header element;
coupling, via an adhesive, a piezoresistive sensing element to the header element;
electrically coupling the piezoresistive sensing element to the one or more header pins;
welding a corrugated diaphragm between the header element and the weld ring such that the diaphragm, along with the header element, defines a cavity;
coupling, via an adhesive, a plastic spacer to the header element within the cavity defined by the diaphragm and the header element; and
filling, with a silicone oil, at least a remaining portion of the cavity defined by the diaphragm and the header element.

16. The method of claim 15, further comprising at least one of:
resistance welding the header element to a metal plate, wherein the header element comprises a protruding, pointed edge in physical contact with the metal plate; or
laser welding the header element to the metal plate, wherein the header element comprises a substantially flat edge with no corner break in physical contact with the metal plate.

17. The method of claim 15, wherein the weld ring is comprised of metal and wherein the header element is a transistor outline (TO) header element comprised of metal.

18. The method of claim 15, further comprising decreasing, by disposing the plastic spacer within the cavity defined by the diaphragm and the header element, a volume of the silicone oil filling at least the remaining portion of the cavity.

19. The method of claim 15, wherein the silicone oil is ECO-704 oil.

20. The method of claim 15, further comprising defining one or more cavities in the header element for oil filling or sensing element placement.
